(19) United States
(12) Patent Application Publication
(10) Pub. No.: US 2014/0258201 A1
(43) Pub. Date: Sep. 11, 2014

(54) GENERATING A GEOFENCE VIA AN ANALYSIS OF A GPS FIX UTILIZATION DISTRIBUTION

(71) Applicant: QUALCOMM INCORPORATED, San Diego, CA (US)

(72) Inventor: Keir Finlow-Bates, Kangasala (FI)

(73) Assignee: QUALCOMM INCORPORATED, San Diego, CA (US)

(21) Appl. No.: 13/786,179

(22) Filed: Mar. 5, 2013

(51) Int. Cl. G06N 5/02

(52) U.S. Cl. CPC G06N 5/02
USPC 706/46

(57) ABSTRACT

Example methods, apparatuses, or articles of manufacture are disclosed herein that may be utilized, in whole or in part, to facilitate or support one or more operations or techniques for generating a geofence via an analysis of a GPS fix utilization distribution, such as for use in or with a mobile communication device. Briefly, in accordance with at least one implementation, a method may include obtaining multiple position fixes of one or more objects over an area or volume; determining a clustering of the multiple position fixes in a portion of the area or volume; and inferring a geofence boundary bounding the portion of the area or volume based, at least in part, on the clustering of the multiple position fixes, for example.

### BACKGROUND

1. Field

The present disclosure relates generally to position or location estimations of mobile communication devices and, more particularly, to generating a geofence via an analyses of a GPS fix utilization distribution for use in or with mobile communication devices.

2. Information

Mobile communication devices, such as, for example, cellular telephones, personal digital assistants, electronic book readers, portable navigation units, laptop computers, or the like are becoming more common every day. As geographic barriers to personal travel decrease, mobile communication devices play a role in allowing society to maintain its mobility. Continued advancements in information technology, communications, mobile applications, or the like help to contribute to a rapidly growing market for mobile communication devices, which have become ubiquitous and may already be viewed as “extensions of the hand” altering the manner in which society communicates, does business, or creates value.

Certain mobile communication devices may, for example, feature a location-aware or location-tracking capability to assist users in estimating their geographic locations by providing position information obtained or gathered from various systems. For example, a mobile communication device may obtain a location estimate or so-called “position fix” by acquiring wireless signals from a satellite positioning system (SPS), such as the global positioning system (GPS) or other like Global Navigation Satellite System (GNSS), cellular base station, location beacon, or the like via a cellular telephone or other wireless communications network. Received wireless signals may, for example, be processed by or at a mobile communication device, and its location may be estimated using one or more appropriate techniques, such as, for example, Advanced Forward Link Trilateration (AFLT), base station identification, or the like.

In some instances, certain location-aware mobile communication devices may employ a so-called “geofence” bounding a geographic region of interest so as to detect entries into or exits from the region in conjunction with a position fix obtained via a suitable positioning technique. A geofence may comprise a virtual boundary on a geographic area established in connection with a suitable location-based service (LBS), for example, such that if a tracked mobile communication device enters or exits the area a notification is generated. A notification may be provided via an e-mail, text message, etc. and may comprise, for example, information about a location of a tracked mobile communication device, time of crossing a geofence boundary or so-called geofence breach, a location of the mobile device relative to a geofence, or the like.

Typically, although not necessarily, a geofence may be generated by defining or expressing in some manner a virtual boundary over a portion of a suitable two-dimensional area or three-dimensional volume. For example, a regional planner, architect, system operator, or like user may determine and input a set of geofence-related parameters into an applicable system, define a geofence boundary over a displayed geographical map, or the like. At times, however, a process of generating or otherwise implementing a geofence may involve more user effort, such as with respect to determining or manually entering geofence-related parameters, for example. This may be time-consuming, error-prone, or computationally expensive. In addition, certain geofences, such as three-dimensional (3D) geofences, for example, may be relatively difficult to visualize. Accordingly, how to generate or otherwise implement geofences in a more effective or efficient manner continues to be an area of development.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating a summary of an implementation of an example process for generating a geofence via an analysis of a GPS fix utilization distribution.

FIG. 3 is a schematic illustration of an implementation of an example scattergraph of position fixes.

FIG. 4 is a schematic illustration of an implementation of example probability density functions of position fixes.

FIG. 5 is a flow diagram illustrating an implementation of an example histogram of position fixes.

FIG. 6 is a schematic diagram illustrating an implementation of an example computing environment associated with a mobile device.

FIG. 7 is a schematic diagram illustrating an implementation of an example computing environment associated with a server.

### SUMMARY

Example implementations relate to generating a geofence via an analysis of a GPS fix utilization distribution for use in or with a mobile communication device. In one implementation, a method may comprise obtaining multiple position fixes of one or more objects over an area or volume; determining a clustering of the multiple position fixes in a portion of the area or the volume; and inferring a geofence boundary bounding the portion of the area or the volume based, at least in part, on the clustering of the multiple position fixes.

In another implementation, an apparatus may comprise one or more processors programmed with instructions to obtain multiple position fixes of one or more objects over an area or volume; determine a clustering of the multiple position fixes in a portion of the area or the volume; and infer a geofence boundary bounding the portion of the area or the volume based, at least in part, on the clustering of the multiple position fixes.

In yet another implementation, an apparatus may comprise means for obtaining multiple position fixes of one or more objects over an area or volume; means for determining a clustering of the multiple position fixes in a portion of the area or the volume; and means for inferring a geofence boundary bounding the portion of the area or the volume based, at least in part, on the clustering of the multiple position fixes.

In yet another implementation, an article may comprise a non-transitory storage medium having instructions stored thereon executable by a special purpose computing platform to obtain multiple position fixes of one or more objects over an area or volume; determine a clustering of the multiple position fixes in a portion of the area or the volume; and infer a geofence boundary bounding the portion of the area or the volume based, at least in part, on the clustering of the multiple position fixes. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations or techniques for generating a geofence via an analysis of a GPS fix utilization distribution for use in or with a mobile communication device. As used herein, “mobile device,” “tracked mobile device,” “mobile communication device,” “wireless device,” “location-aware mobile device,” or the plural form of such terms may be used interchangeably and may refer to any kind of special purpose computing platform or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, or the like. It should be appreciated, however, that these are merely examples of mobile devices that may be used, at least in part, to implement one or more operations or processes for generating a geofence via one or more techniques described herein, and that claimed subject matter is not limited in this regard. It should also be noted that the terms “position” and “location” may be used interchangeably herein.

As previously mentioned, in some instances, a location-tracking or like LBS application hosted on a mobile device may, for example, employ a geofence bounding a geographic region of interest to detect an entry into or exit from the region. This may be implemented in conjunction with one or more GPS or like GNSS position fixes obtained via a suitable positioning technique. The terms “GPS fix,” “GNSS fix,” “position fix,” or the like may be used interchangeably herein. For example, a geofence may be employed to determine whether a tracked mobile device, such as carried by a truck, car, person, etc. has crossed or breached a geofence boundary from the inside or outside. As was also indicated, at times, generating or implementing a geofence may involve, for example, manually inputting or expressing a set of geofence-related parameters. For a relatively simple geofence, such as a two-dimensional (2D) geofence with a circular boundary, for example, this process may not be too onerous. However, for a more complex geofence, such as a 3D polygonal geofence, for example, defining or expressing a set of suitable parameters may involve more effort on the part of a system operator or like user. In addition, in some instances, relatively complex geofences may be more difficult to visualize. Accordingly, it may be desirable to develop one or more methods, systems, or apparatuses that may implement more effective or efficient geofence generation, which may lead to a better user experience, increase usability of a geofence, associated service, mobile device, applicable technology, or the like.

Thus, as will be described in greater detail below, a history of GPS position fixes obtained or gathered via one or more mobile devices co-located with users may, for example, be utilized, at least in part, to define or implement a suitable geofence in a more effective or efficient manner. For example, depending on an implementation, a number of GPS position fixes may be obtained over a geographic area or volume and may be clustered over time using one or more appropriate techniques. Based, at least in part, on such a clustering, a geofence boundary may be inferred, and an associated geofence may be named, labeled, or otherwise designated in some manner. As will be seen, because GPS position fixes may be obtained or gathered via a mobile device (e.g., without active participation of a user, etc.), in three-dimensional space, and in relation to time, a process of geofence generation may be more dynamic or, at times, automatic, and a resulting geofence boundary may be more contextually as well as temporally relevant.

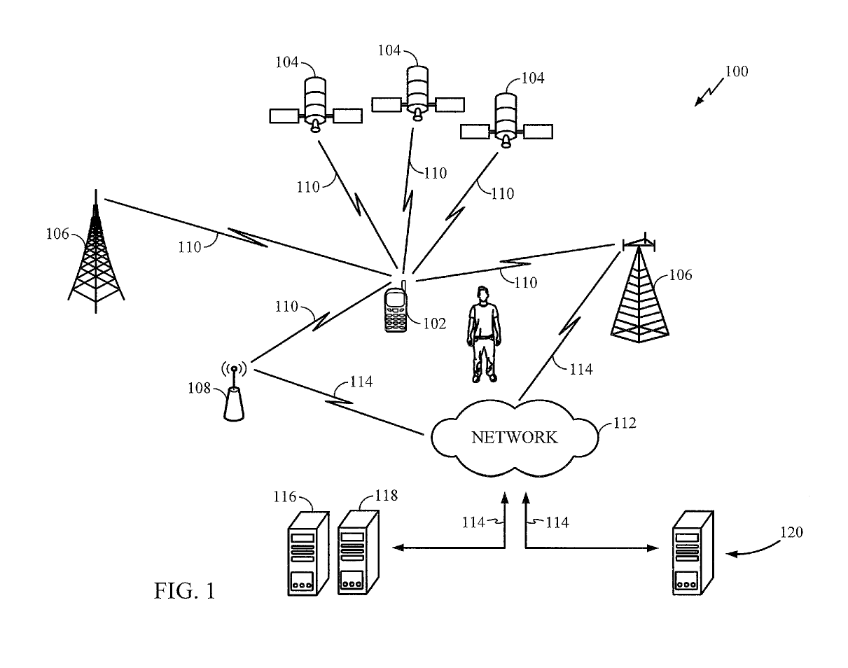

FIG. 1 is a schematic diagram illustrating features associated with an implementation of an example operating environment 100 capable of facilitating or supporting one or more processes or operations for generating a geofence via an analysis of a GPS fix utilization distribution. As was indicated, a geofence may be generated or implemented, in whole or in part, via a suitable mobile device co-located with a user, such as a mobile device 102, for example. It should be appreciated that operating environment 100 is described herein as a non-limiting example that may be implemented, in whole or in part, in the context of various communications networks or combination of networks, such as public networks (e.g., the Internet, the World Wide Web), private networks (e.g., intranets), wireless local area networks (WLAN), wireless wide area networks (WWAN), mobile ad-hoc networks (MANET), wireless mesh networks (WMN), wireless sensor networks (WSN), wireless personal area network (WPAN), or the like. Operating environment 100 may, for example, be communicatively enabled using one or more special purpose computing platforms, communication devices, information storage devices, databases, computer-readable codes or instructions, e-mail or text messaging information, specific applications or functionalities, various electrical or electronic circuitry or components, etc., as described herein with reference to one or more example implementations.

As illustrated, operating environment 100 may comprise, for example, one or more satellites 104, base transceiver stations 106, wireless transmitters 108, etc. capable of communicating with mobile device 102 via wireless communication links 110 in accordance with one or more communication protocols. Satellites 104 may be associated with one or more satellite positioning systems (SPS), such as, for example, the United States Global Positioning System (GPS), the Russian GLONASS system, the European Galileo system, as well as any system that may utilize satellites from a combination of satellite systems, or any satellite system developed in the future. Base transceiver stations 106, wireless transmitters 108, etc. may be of the same or similar type, for example, or may represent different types of devices, such as access points, radio beacons, cellular base stations, femtocells, or the like, depending on an implementation. At times, one or more wireless transmitters, such as wireless transmitters 108, for example, may be capable of transmitting as well as receiving wireless signals.

In some instances, one or more base transceiver stations 106, wireless transmitters 108, etc. may, for example, be operatively coupled to a network 112 that may comprise one or more wired or wireless communications or computing networks or resources capable of providing suitable information, such as via one or more communication links 114. Information may include, for example, one or more geofence-related parameters or attributes (e.g., altitude, latitude, longitude, time, etc.), estimated location of mobile device 102 (e.g., a GPS position fix, etc.), digital map-related information, LBS-related information, wireless or wired carrier-related information, or the like. At times, information may include, for example, an analysis of one or more applicable GPS fix utilization distributions or any portion thereof, geofence names or labels, or the like. Of course, these are merely examples relating to information that may be communicated via one or more communication links, such as links 110, 114, etc., and claimed subject matter is not so limited.

In an implementation, network 112 may be capable of facilitating or supporting communications between or among suitable computing platforms or devices, such as, for example, mobile device 102, one or more satellites 104, base transceiver stations 106, wireless transmitters 108, etc., as well as one or more servers associated with operating environment 100. In some instances, servers may include, for example, a location server 116, geofence data server 118, as well as one or more other servers, indicated generally at 120 (e.g., navigation, map, etc. server), capable of facilitating or supporting one or more operations or processes associated with operating environment 100. Location server 116 may, for example, provide a GPS position fix with respect to mobile device 102, such as by acquiring wireless signals from satellites 104, base transceiver stations 106, wireless transmitters 108, etc. using one or more appropriate techniques (e.g., AFLT, AGPS, etc.), may store a history of GPS position fixes obtained over a period time, or the like. Geofence data server 118 may be used, at least in part, by mobile device 102 to obtain suitable geofence-related information, such as one or more geofence-related parameters or attributes, geofence names or labels, or the like. Server 120 may provide any other suitable information that may facilitate or support one or more operations or processes for creating a geofence via an analysis of a GPS fix utilization distribution. For example, server 120 may provide a digital map for a geofence, an analysis of a GPS fix utilization distribution or any part thereof, appropriate data or graphs (e.g., scattergraphs, histograms, plots, etc.), or the like.

It should be appreciated that even though a certain number or type of computing platforms or devices are illustrated herein, any number or type of computing platforms or devices may be implemented herein to facilitate or support one or more techniques or processes associated with operating environment 100. At times, network 112 may, for example, be coupled to one or more other wired or wireless communications networks (e.g., Wi-Fi, WLAN, WWAN, etc.) so as to enhance a coverage area for communications with mobile device 102, one or more base transceiver stations 106, wireless transmitters 108, applicable servers, or the like. For example, in some instances, network 112 may facilitate or support femtocell-based or like operative regions of coverage, just to illustrate one possible implementation. Again, operating environment 100 is merely an example, and claimed subject matter is not limited in this regard.

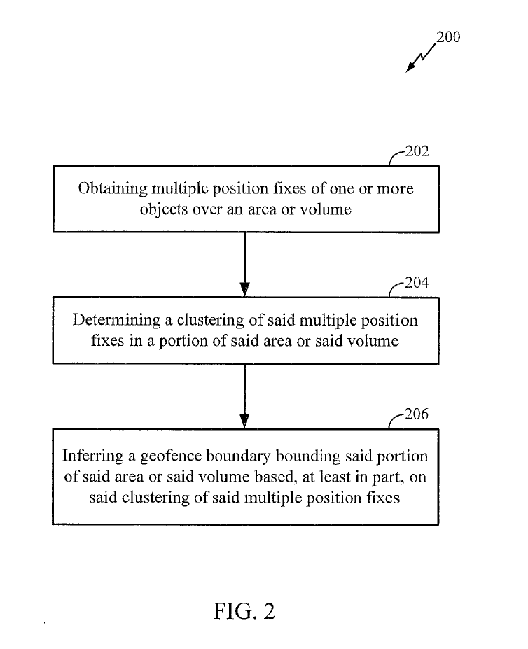

With this in mind, attention is now drawn to FIG. 2, which is a flow diagram illustrating a summary of an implementation of an example process 200 that may be performed, in whole or in part, to facilitate or support generating a suitable geofence, such as via an analysis of a GPS fix utilization distribution, for example. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

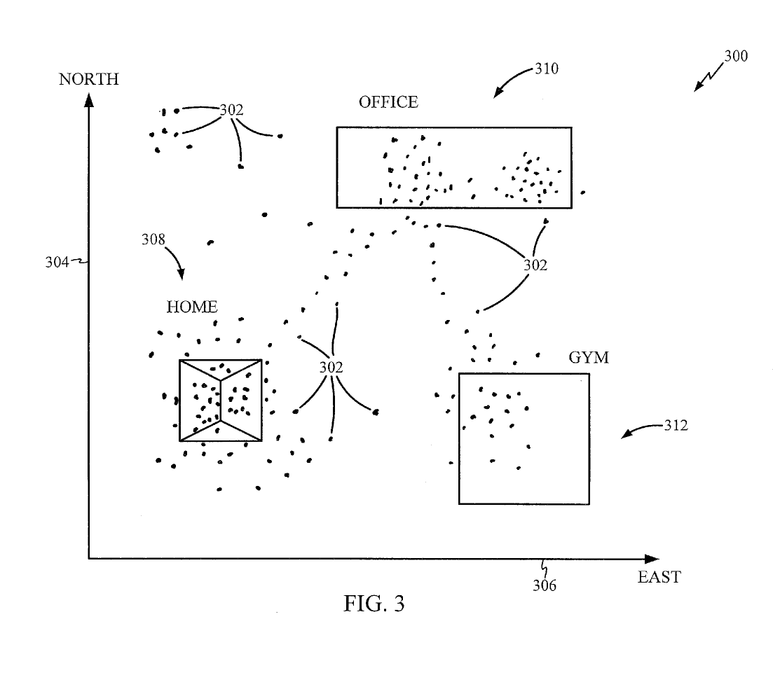

Example process 200 may, for example, begin at operation 202 with obtaining multiple position fixes of one or more objects over an area or volume. As previously discussed, position fixes may be obtained by acquiring wireless signals from the GPS or like GNSS via a cellular telephone or other wireless communications network, just to illustrate one possible implementation. In some instances, multiple position fixes may, for example, be obtained or determined based, at least in part, on a mobile device co-located with a user. For example, a mobile device may be configured in some manner, such as manually by a user, automatically on initial use or on accepting terms and conditions of an application, etc., to gather position fixes over a certain period of time (e.g., during one day, one week, etc.). As seen in FIG. 3, gathered position fixes may be plotted on a geographical map so as to generate a scattergraph 300 comprising one or more objects 302 representing estimated locations of a mobile device co-located with a particular user and obtained over a suitable area. It should be appreciated that even though position fixes on scattergraph 300 are specified via two axes of cardinal directions, such as North (latitude), indicated at 304, and East (longitude), indicated at 306, three mutually orthogonal directions representative of a volume (e.g., up/down or altitude, North/South or latitude, and East/West or longitude) may be used, in whole or in part. As was also indicated, time may be included in these multiple position fixes so as to define or characterize a timespan in which a resulting geofence boundary may be valid, applicable, or otherwise useful.

In some instances, GPS position fixes may be gathered or obtained, at least in part, via one or more crowd-sourcing techniques, though claimed subject matter is not so limited. For example, users of mobile devices may execute desired tasks (e.g., store or communicate position fixes, etc.) and be rewarded in some manner for doing so, just to illustrate one possible example. Optionally or alternatively, an LBS may extract, upon authorization, a history of position fixes from a location-aware unit associated with mobile devices co-located with traveling users, for example. A history of position fixes may be stored on a suitable server (e.g., location server 116 of FIG. 1, etc.), for example, and may be subsequently shared between or otherwise queried by a mobile device, suitable server, etc. to facilitate one or more operations or processed discussed herein. Optionally or alternatively, a history of GPS position fixes may be stored in a memory of a mobile device, for example, to facilitate or support one or more processes or operations for generating a geofence on the mobile device.

Referring back to process 200 of FIG. 2, at operation 204, a clustering of multiple position fixes in a portion of an area or volume may, for example, be determined. For example, at times, a clustering may be determined based, at least in part, on at least one attribute of position fixes, such as latitude, longitude, altitude, time, or any combination thereof using any suitable statistical approach, as discussed below. In some instances, a clustering may be determined based, at least in part, on at least one attribute of a user of a co-located mobile device. For example, a user may share one or more common attributes with certain other users, such as age group, membership in a sports team, mobile device's model or host application, seasonal ticket holders for a sports event, or the like. As such, their GPS position fixes may, for example, be clustered to characterize one or more applicable geographic areas for geofence generation. As a way of illustration, a clustering of season ticket holders at a certain time or in a certain space may, for example, be indicative of a stadium or a portion of a stadium that may be bounded via a geofence. A clustering of members of a sports team in time or space may be indicative of a practice field, just to illustrate another possible example.

Here, one or more suitable statistical approaches or methods may, for example, be applied to a clustering so as to produce one or more probability density functions of multiple GPS position fixes. By way of example but not limitation, a histogram-type distribution, kernel density-type estimation, or like approaches may be used, in whole or in part. These statistical approaches or methods are generally known and need not be described herein in greater detail. As further illustrated in FIG. 3, in some instances, a clustering of one or more objects 302 may correspond to or correlate with a particular portion of scattergraph 300. For example, in certain simulations or experiments, it has been observed that a clustering may be indicative of a particular place or function of a particular place, may be descriptive of a certain pastime or activity of a user, or the like. As a way of illustration, a clustering of multiple GPS position fixes of a user obtained in evening hours may, for example, be indicative of a home location, as indicated generally at 308. As another possible example, a clustering of position fixes of a user during typical work hours may be indicative of the user's work office, as indicated via an arrow at 310. As yet another example, a clustering of position fixes during hours in which a user typically attends a gym may be indicative of a location of the gym, as indicated at 312. Of course, these are merely examples relating to a clustering of multiple position fixes, and claimed subject matter is not so limited.

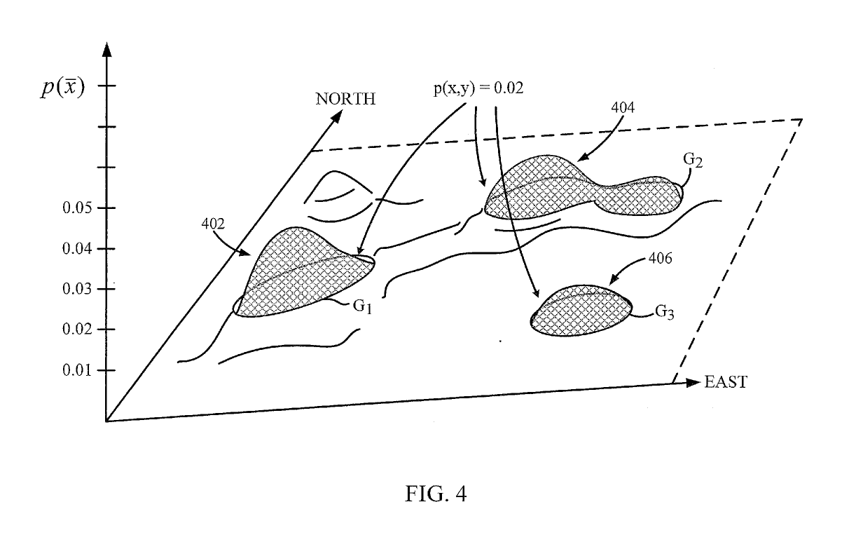

Continuing with FIG. 2, at operation 206, a geofence boundary bounding a portion of an area or volume may, for example, be inferred based, at least in part, on a clustering of multiple position fixes. For example, as alluded to previously, in some instances, a probability density function applied to a suitable clustering may, for example, be utilized, in whole or in part. Typically, although not necessarily, a probability density function may be indicative of a likelihood that certain GPS position fixes (e.g., plotted as a clustering on scattergraph 300, etc.) may be within a geographic area of interest. As was indicated, a probability density function may be determined using any suitable statistical method or approach, such as discussed above. In one particular simulation or experiment, probability density functions determined for multiple position fixes of clustering 308, 310, and 312 of FIG. 3 included those illustrated in a distribution plot 400 of FIG. 4. Again, it should be appreciated that variables, probabilities, values, directions, etc. shown are merely examples to which claimed subject matter is not limited.

As illustrated, probability density functions may be represented via peaks 402, 404, and 406 that may be indicative of or correspond to a home location (e.g., for clustering 308 of FIG. 3), work office (e.g., for clustering 310 of FIG. 3), and a gym (e.g., for clustering 312 of FIG. 3), respectively. As shown, here, geofence boundaries may, for example, be inferred by defining contours G1, G2, and G3 around peaks 402, 404, and 406 of respective probability density functions to generate geofences in which a user was situated for more than a certain period of time. Thus, a geofence boundary defined by each peak 402, 404, and 406 at a threshold number of multiple position fixes, characterized herein as a set percentage (e.g. more than 30% of multiple position fixes, etc.), may correspond to each respective geofence. A threshold number of multiple position fixes may be determined experimentally and may be pre-defined or configured, for example, or otherwise dynamically defined in some manner, depending on a particular application, geographic area, time of day, day of week, geofence-related parameters or attributes, or the like. By way of example but not limitation, in one particular simulation or experiment, contours with p(x, y)≧0.02 were used to infer boundaries of one or more geofences. Also, volume under each surface of peaks 402, 404, and 406 is equal to one. Again, it should be noted that time may also be included in a probability density function for inferring a geofence boundary. As such, a resulting geofence may, for example, reference a timespan in which the boundary may be valid, applicable, or otherwise useful (e.g., a geofence is up from 9 a.m. to 5 p.m., Monday through Friday, etc.). Of course, these are merely details relating to thresholds, probabilities, geofence boundaries, etc., and claimed subject matter is not limited in this regard.

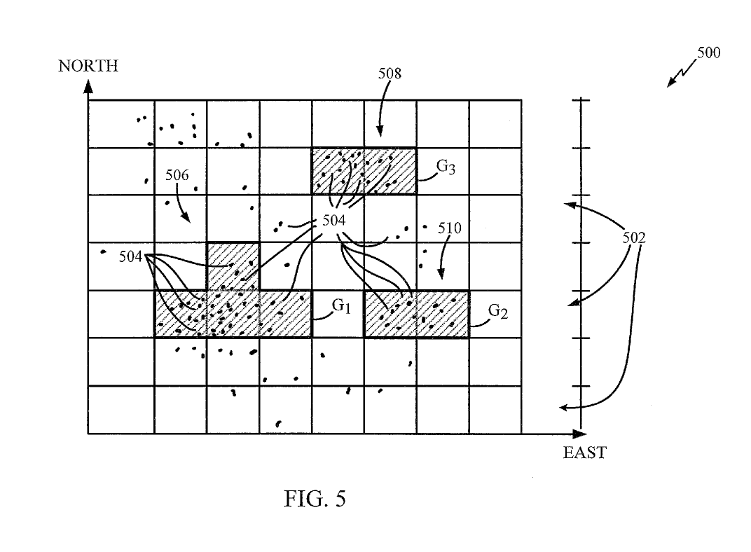

In at least one implementation, as illustrated in FIG. 5, one or more geofence boundaries may be inferred or identified based, at least in part, on a respective probability density function determined or estimated via a histogram-type distribution of multiple position fixes. For example, an area or volume of a suitable histogram, such as a histogram 500, may be partitioned into a plurality of sufficiently small square segments 502. Multiple position fixes of one or more objects 504 within each segment 502 may be subsequently counted, and one or more contiguous segments bounding segments 502 with position fixes above a certain threshold (e.g. more than 30% of multiple position fixes, etc.) may be identified. These one or more identified contiguous segments bounding one or more segments 502 may comprise, for example, or be representative of respective geofence boundaries. For this example, geofences 506, 508, and 510 may be inferred by identifying contiguous segments G1, G2, and G3 having a number of position fixes within associated segments 502 above a given threshold. Again, claimed subject matter is not limited to geofence boundaries, position fixes, values, thresholds etc. illustrated.

In some instances, a generated geofence may be assigned or given a name or label, such as by extracting named destinations from a memory of a mobile device (e.g., from “Favorites” folder, etc.), by prompting a user for name or label selection, or the like. For example, a user may be presented with an applicable geofence displayed on a digital map on a mobile device and may be asked to label or name the geofence in some manner (e.g., “home,” “work office,” “gym,” etc.). Depending on an implementation, one or more geofence definitions, labels, names, parameters, attributes, or the like may be communicated or uploaded to a suitable server (e.g., server 118, 120, etc. of FIG. 1), such as for sharing with other users or services, for example. Also, obtained GPS position fixes from different users may be gathered or pooled in some manner on a suitable server (e.g., server 116, etc. of FIG. 1) in order to determine popular destinations (e.g., sports bars, restaurants, museums, landmarks, etc.) via one or more crowd-sourcing techniques, as discussed above.

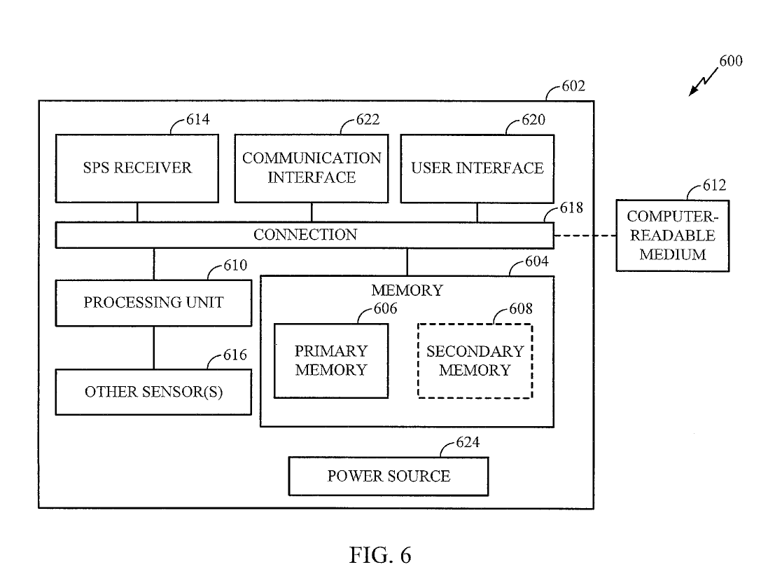

FIG. 6 is a schematic diagram illustrating an implementation of an example computing environment 600 that may include one or more mobile devices capable of partially or substantially implementing or supporting one or more operations or processes for generating a geofence via an analysis of a GPS fix utilization distribution. It should be appreciated that all or part of various devices shown in computing environment 600, processes, or methods, as described herein, may be implemented using various hardware, firmware, or any combination thereof along with software.

Example computing environment 600 may comprise, for example, a mobile device 602 that may include one or more features or aspects of mobile device 102 of FIG. 1, though claimed subject matter is not so limited. For example, mobile device 602 may be capable of communicating with one or more other devices, mobile or otherwise, via a cellular telephone network, the Internet, mobile ad-hoc network, wireless sensor network, or the like. In an implementation, mobile device 602 may be representative of any electronic or computing device, machine, appliance, or platform that may be capable of exchanging information over any suitable network. For example, mobile device 602 may include one or more computing devices or platforms associated with, for example, cellular telephones, satellite telephones, smart telephones, personal digital assistants (PDAs), laptop computers, personal entertainment systems, e-book readers, tablet personal computers (PC), personal audio or video devices, personal navigation devices, or the like. In certain example implementations, mobile device 602 may take the form of one or more integrated circuits, circuit boards, or the like that may be operatively enabled for use in another device. Thus, unless stated otherwise, to simplify discussion, various functionalities, elements, components, etc. are described below with reference to mobile device 602 may also be applicable to other devices not shown so as to support one or more processes associated with example computing environment 600.

Although not shown, optionally or alternatively, there may be additional devices, mobile or otherwise, communicatively coupled to mobile device 602 to facilitate or otherwise support one or more processes associated with computing environment 600, such as discussed above. For example, computing environment 600 may include various computing or communication resources or devices capable of obtaining all or part of position or location information with regard to mobile device 602, applicable geofence-related parameters or attributes, etc. based, at least in part, on one or more wireless signals associated with a positioning system, location-based service, or the like. Location information may, for example, be stored in some manner in memory 604 along with other suitable or desired information, such as one or more parameters for a geofence or user, distribution plots, histograms, cellular or like wireless communications network, or the like.

Memory 604 may represent any suitable information storage medium. For example, memory 604 may include a primary memory 606 and a secondary memory 608. Primary memory 606 may include, for example, a random access memory, read only memory, etc. While illustrated in this example as being separate from a processing unit 610, it should be appreciated that all or part of primary memory 606 may be provided within or otherwise co-located/coupled with processing unit 610. Secondary memory 608 may include, for example, the same or similar type of memory as primary memory or one or more information storage devices or systems, such as, for example, a disk drive, an optical disc drive, a tape drive, a solid state memory drive, etc. In certain implementations, secondary memory 608 may be operatively receptive of, or otherwise enabled to be coupled to, a computer-readable medium 612.

Computer-readable medium 612 may include, for example, any medium that may store or provide access to information, code or instructions (e.g., an article of manufacture, etc.) for one or more devices associated with computing environment 600. For example, computer-readable medium 612 may be provided or accessed by processing unit 610. As such, in certain example implementations, the methods or apparatuses may take the form, in whole or part, of a computer-readable medium that may include computer-implementable instructions stored thereon, which may be executed by at least one processing unit or other like circuitry so as to enable processing unit 610 or the other like circuitry to perform all or portions of a location determination processes, geofence generation processes, GPS fix utilization distribution processes, or any processes to facilitate or support one or more operations or techniques discussed herein. In certain example implementations, processing unit 610 may be capable of performing or supporting other functions, such as geofence breach detection, communications, navigations, video gaming, or the like.

It should be understood that a storage medium, such as memory 604, computer-readable medium 612, etc. may typically, although not necessarily, be non-transitory or may comprise a non-transitory device. In this context, a non-transitory storage medium may include, for example, a device that is physical or tangible, meaning that the device has a concrete physical form, although the device may change state. For example, one or more electrical binary digital signals representative of information, in whole or in part, in the form of zeros may change a state to represent information, in whole or in part, as binary digital electrical signals in the form of ones, to illustrate one possible implementation. As such, “non-transitory” may refer, for example, to any medium or device remaining tangible despite this change in state.

Processing unit 610 may be implemented in hardware or a combination of hardware and software. Processing unit 610 may be representative of one or more circuits capable of performing at least a portion of information computing technique or process. By way of example but not limitation, processing unit 610 may include one or more processors, controllers, microprocessors, microcontrollers, application specific integrated circuits, digital signal processors, programmable logic devices, field programmable gate arrays, or the like, or any combination thereof. Thus, at times, processing unit 610 may comprise, for example, or be representative of means for obtaining multiple position fixes of one or more objects over an area or volume, means for determining a clustering of multiple position fixes in a portion of an area or volume, and means for inferring a geofence boundary bounding a portion of an area or volume based, at least in part, on a clustering of multiple position fixes, such as discussed above with respect to various example implementations.

Mobile device 602 may include various sensors, components, or circuitry, such as, for example, an SPS receiver 614 capable of acquiring wireless signals from a satellite positioning system (SPS), such as the global positioning system (GPS) or other like Global Navigation Satellite System (GNSS), cellular base station, location beacon, or the like. Although not shown, mobile device 602 may include a location-tracking unit that may initiate a position fix of mobile device 602, such as with respect to a potential or current geofence of interest, for example, based, at least in part, on one or more received or acquired wireless signals, such as from an SPS. In some implementations, a location-tracking unit may be at least partially integrated with a suitable processing unit, such as processing unit 610, for example, though claimed subject matter is not so limited. Mobile device 602 may include one or more other sensors 616, such as, for example, an accelerometer, magnetometer, ambient light detector, camera imager, microphone, temperature sensor, atmospheric pressure sensor, etc. to facilitate or otherwise support one or more processes associated with computing environment 600. For example, sensors may provide analog or digital signals to processing unit 610. Although not shown, it should be noted that mobile device 602 may include an analog-to-digital converter (ADC) for digitizing analog signals from one or more sensors. Optionally or alternatively, such sensors may include a designated (e.g., an internal, etc.) ADC(s) to digitize signals, although claimed subject matter is not so limited.

Mobile device 602 may include one or more connections 618 (e.g., buses, lines, conductors, optic fibers, etc.) to operatively couple various circuits together, and a user interface 620 (e.g., display, touch screen, keypad, buttons, knobs, microphone, speaker, trackball, information port, etc.) to receive user input, facilitate or support creating geofence assistance information, provide information to a user, or the like. Mobile device 602 may further include a communication interface 622 (e.g., wireless transmitter or receiver, modem, antenna, etc.) to allow for communication with one or more other devices or systems over one or more suitable communications networks, as was also indicated.

In an implementation, mobile device 602 may include a power source 624 to provide power to some or all of the sensors, components, or circuitry. Power source 624 may be a portable power source, such as a battery, for example, or may comprise a fixed power source, such as an outlet (e.g. in a house, electric charging station, car, etc.). It should be appreciated that power source 624 may be integrated into (e.g., built-in, etc.) or otherwise supported by (e.g., stand-alone, etc.) mobile device 602. Although not shown, mobile device 602 may also include a memory or information buffer to collect suitable or desired information, such as, for example, a history of GPS position fixes, clustering of multiple position fixes, geofence-related parameters, user-related attributes, or the like.

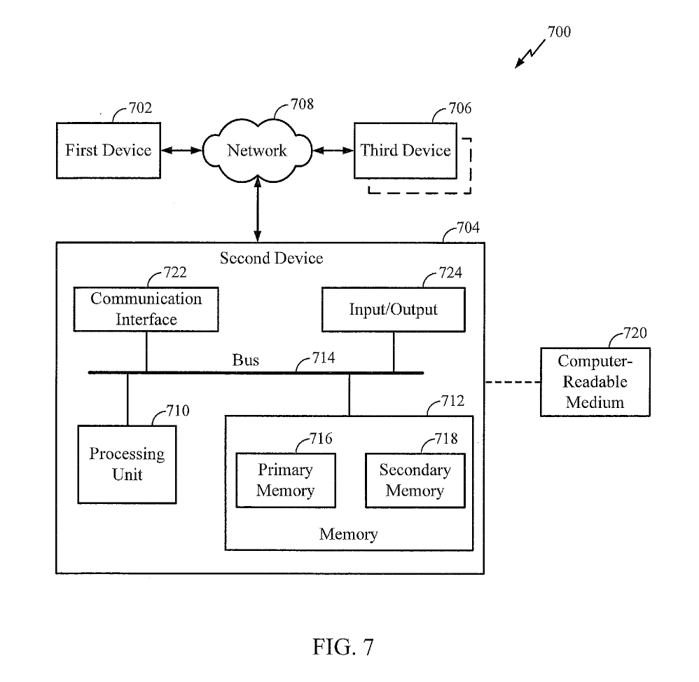

FIG. 7 is a schematic diagram illustrating an implementation of an example computing environment 700 that may include one or more servers or other devices capable of partially or substantially implementing or supporting one or more operations or processes for generating a geofence via an analysis of a GPS fix utilization distribution, such as discussed above in connection with FIGS. 1-5, for example. Computing environment 700 may include, for example, a first device 702, a second device 704, a third device 706, etc., which may be operatively coupled together via a communications network 708.

First device 702, second device 704, or third device 706 may be representative of any device, appliance, platform, or machine that may be capable of exchanging information over communications network 708. By way of example but not limitation, any of first device 702, second device 704, or third device 706 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 702, 704, and 706, respectively, may comprise one or more of a mobile device, wireless transmitter or receiver, server, etc. in accordance with example implementations described herein.

In an implementation, communications network 708 may be representative of one or more communication links, processes, or resources capable of supporting an exchange of information between at least two of first device 702, second device 704, or third device 706. By way of example but not limitation, communications network 708 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 706, there may be additional like devices operatively coupled to communications network 708. It is also recognized that all or part of various devices or networks shown in computing environment 700, or processes or methods, as described herein, may be implemented using or otherwise including hardware, firmware, software, or any combination thereof.

By way of example but not limitation, second device 704 may include at least one processing unit 710 that may be operatively coupled to a memory 712 via a bus 714. Processing unit 710 may be representative of one or more circuits capable of performing at least a portion of a suitable computing procedure or process. For example, processing unit 710 may include one or more processors, controllers, microprocessors, microcontrollers, application specific integrated circuits, digital signal processors, programmable logic devices, field programmable gate arrays, or the like, or any combination thereof. Although not shown, second device 704 may include a location-tracking unit that may initiate a position fix of a tracked mobile device, such as with respect to a geofence boundary of interest, for example, based, at least in part, on one or more received or acquitted wireless signals, such as from an SPS. In some implementations, a location-tracking unit may be at least partially integrated with a suitable processing unit, such as processing unit 710, for example, though claimed subject matter is not so limited. In certain server-based or server-supported implementations, processing unit 710 may comprise, for example, or be representative of means for obtaining multiple position fixes of one or more objects over an area or volume, means for determining a clustering of multiple position fixes in a portion of an area or volume, as well as means for inferring a geofence boundary bounding a portion of an area or volume based, at least in part, on a clustering of multiple position fixes, as illustrated in or described with respect to operations 202-206 of FIG. 2.

Memory 712 may be representative of any information storage mechanism or appliance. Memory 712 may include, for example, a primary memory 716 and a secondary memory 718. Primary memory 716 may include, for example, a random access memory, read only memory, etc. While illustrated in this example as being separate from processing unit 710, it should be understood that all or part of primary memory 716 may be provided within or otherwise co-located/coupled with processing unit 710. Secondary memory 718 may include, for example, same or similar type of memory as primary memory or one or more information storage devices or systems, such as, for example, a disk drive, an optical disc drive, a tape drive, a solid state memory drive, etc. In certain implementations, secondary memory 718 may be operatively receptive of, or otherwise configurable to couple to, a computer-readable medium 720. Computer-readable medium 720 may include, for example, any non-transitory storage medium that may carry or make accessible information, code, or instructions for one or more of devices in computing environment 700. Computer-readable medium 720 may also be referred to as a storage medium.

Second device 704 may include, for example, a communication interface 722 that may provide for or otherwise support an operative coupling of second device 704 to at least communications network 708. By way of example but not limitation, communication interface 722 may include a network interface device or card, a modem, a router, a switch, a transceiver, and the like. Second device 704 may also include, for example, an input/output device 724. Input/output device 724 may be representative of one or more devices or features that may be configurable to accept or otherwise introduce human or machine inputs, or one or more devices or features that may be capable or delivering or otherwise providing for human or machine outputs. By way of example but not limitation, input/output device 724 may include an operatively configured display, speaker, keyboard, mouse, trackball, touch screen, information port, or the like.

Methodologies described herein may be implemented by various means depending upon applications according to particular features or examples. For example, such methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, the methodologies may be implemented with modules (e.g., procedures, functions, etc.) having instructions that perform functions described herein. Any machine readable medium tangibly embodying instructions may be used in implementing methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. In at least some implementations, one or more portions of the herein described storage media may store signals representative of information as expressed by a particular state of the storage media. For example, an electronic signal representative of information may be “stored” in a portion of the storage media (e.g., memory) by affecting or changing the state of such portions of the storage media to represent information as binary information (e.g., via ones and zeros). As such, in a particular implementation, such a change of state of the portion of the storage media to store a signal representative of information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to store desired program code in the form of instructions or information structures and that may be accessed by a computer or processor thereof. Disk and disc, as used herein, includes compact disc (CD), laser disc, optical disc, digital versatile disc (DVD), floppy disk and blue-ray disc where disks usually reproduce information magnetically, while discs reproduce information optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN), a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rdGeneration Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In an implementation, a mobile device may, for example, be capable of communicating with one or more femtocells, such as for the purpose of estimating its location, implementing a geofence, communicating with a suitable server, or the like. As used herein, “femtocell” may refer to one or more smaller-size cellular base stations that may be capable of detecting a wireless signal transmitted from a mobile device using one or more appropriate techniques. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA)-2000, or Time Division Synchronous Code Division Multiple Access (TD-SCDMA), to name just a few examples among many possible. In certain implementations, a femtocell may comprise integrated WiFi, for example. However, such details relating to femtocells are merely examples, and claimed subject matter is not so limited.

Also, if applicable, computer-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
obtaining multiple position fixes of one or more objects over an area or volume;
determining a clustering of said multiple position fixes in a portion of said area or said volume; and
inferring a geofence boundary bounding said portion of said area or said volume based, at least in part, on said clustering of said multiple position fixes.

2. The method of claim 1, and further comprising:
partitioning said area into one or more segments;
counting said multiple position fixes within said one or more segments; and
identifying at least one contiguous segment based, at least in part, on at least a threshold number of said multiple position fixes, wherein said inferring said geofence boundary comprises inferring said boundary to bound said at least one contiguous segment.

3. The method of claim 1, wherein said determining said clustering of said multiple position fixes further comprises:
identifying at least one attribute of said multiple position fixes; and
clustering said multiple position fixes based, at least in part, on said at least one attribute.

4. The method of claim 3, wherein said at least one attribute comprises at least one of the following: latitude; longitude; altitude; time; or any combination thereof.

5. The method of claim 4, wherein said time is determined based, at least in part, on at least one of the following: time of day; day of week; day of month; day of year; or any combination thereof.

6. The method of claim 3, wherein said multiple position fixes of said one or more objects are determined based, at least in part, on a mobile device co-located with a user of said mobile device.

7. The method of claim 3, wherein said at least one attribute comprises an attribute of a user of a mobile device co-located with said user.

8. The method of claim 1, wherein said geofence boundary is inferred based, at least in part, on a probability density function of said multiple position fixes of said one or more objects.

9. The method of claim 8, wherein said probability density function is determined based, at least in part, on a scatter graph of said multiple position fixes of said one or more objects.

10. The method of claim 9, wherein said scatter graph is plotted on a geographical map.

11. The method of claim 8, wherein said probability density function is determined based, at least in part, on at least one of the following: a histogram-type distribution of said multiple position fixes; a kernel density-type estimation of said multiple position fixes; or any combination thereof.

12. The method of claim 8, wherein said geofence boundary is inferred to bound a peak of said probability density function defined by at least a threshold number of said multiple position fixes.

13. The method of claim 8, wherein said geofence boundary is inferred to bound a peak of said probability density function defined by at least a threshold number of a density of probability of said multiple position fixes.

14. The method of claim 1, wherein said geofence boundary is associated with at least one of the following: a two-dimensional geofence; a three-dimensional geofence; or any combination thereof.

15. An apparatus comprising:
a communication interface; and
at least one processor programmed with instructions to:
obtain multiple position fixes of one or more objects over an area or volume;
determine a clustering of said multiple position fixes in a portion of said area or said volume; and
infer a geofence boundary bounding said portion of said area or said volume based, at least in part, on said clustering of said multiple position fixes.

16. The apparatus of claim 15, wherein said at least one processor further programmed with instructions to:
partition said area into one or more segments;
count said multiple position fixes within said one or more segments; and
identify at least one contiguous segment based, at least in part, on at least a threshold number of said multiple position fixes, wherein to said infer said geofence boundary comprises to infer said boundary to bound said at least one contiguous segment.

17. The apparatus of claim 15, wherein said at least one processor programmed with said instructions to said determine said clustering of said multiple position fixes further to:
identify at least one attribute of said multiple position fixes; and
cluster said multiple position fixes based, at least in part, on said at least one attribute.

18. The apparatus of claim 17, wherein said at least one attribute comprises at least one of the following: latitude; longitude; altitude; time; or any combination thereof.

19. The apparatus of claim 15, wherein said at least one processor programmed with said instructions to said infer said geofence boundary based, at least in part, on a probability density function of said multiple position fixes of said one or more objects.

20. The apparatus of claim 19, wherein said at least one processor to said infer said geofence boundary further programmed with instructions to bound a peak of said probability density function defined by at least one of the following: a threshold number of said multiple position fixes; a threshold number of a density of probability of said multiple position fixes; or any combination thereof.

21. The apparatus of claim 15, wherein said geofence boundary is associated with at least one of the following: a two-dimensional geofence; a three-dimensional geofence; or any combination thereof.

22. An apparatus comprising:
means for obtaining multiple position fixes of one or more objects over an area or volume;
means for determining a clustering of said multiple position fixes in a portion of said area or said volume; and
means for inferring a geofence boundary bounding said portion of said area or said volume based, at least in part, on said clustering of said multiple position fixes.

23. The apparatus of claim 22, and further comprising:
means for partitioning said area into one or more segments;
means for counting said multiple position fixes within said one or more segments; and
means for identifying at least one contiguous segment based, at least in part, on at least a threshold number of said multiple position fixes, wherein said means for inferring said geofence boundary comprises means for inferring said boundary to bound said at least one contiguous segment.

24. The apparatus of claim 22, wherein said means for determining said clustering of said multiple position fixes further comprises:
means for identifying at least one attribute of said multiple position fixes; and
means for clustering said multiple position fixes based, at least in part, on said at least one attribute.

25. The apparatus of claim 24, wherein said at least one attribute comprises at least one of the following: latitude; longitude; altitude; time; or any combination thereof.

26. The apparatus of claim 25, wherein said time is determined based, at least in part, on at least one of the following: time of day; day of week; day of month; day of year; or any combination thereof.

27. The apparatus of claim 24, wherein said multiple position fixes of said one or more objects are determined based, at least in part, on a mobile device co-located with a user of said mobile device.

28. The apparatus of claim 24, wherein said at least one attribute comprises an attribute of a user of a mobile device co-located with said user.

29. The apparatus of claim 22, wherein said means for inferring said geofence boundary further comprise means for inferring said geofence boundary based, at least in part, on a probability density function of said multiple position fixes of said one or more objects.

30. The apparatus of claim 29, wherein said probability density function is determined based, at least in part, on a scatter graph of said multiple position fixes of said one or more objects.

31. The apparatus of claim 30, wherein said scatter graph is plotted on a geographical map.

32. The apparatus of claim 29, wherein said probability density function is determined based, at least in part, on at least one of the following: a histogram-type distribution of said multiple position fixes; a kernel density-type estimation of said multiple position fixes; or any combination thereof.

33. The apparatus of claim 29, wherein said means for inferring said geofence boundary further comprise means for inferring said geofence boundary to bound a peak of said probability density function defined by at least a threshold number of said multiple position fixes.

34. The apparatus of claim 29, wherein said means for inferring said geofence boundary further comprise means for inferring said geofence boundary to bound a peak of said probability density function defined by at least a threshold number of a density of probability of said multiple position fixes.

35. The apparatus of claim 22, wherein said geofence boundary is associated with at least one of the following: a two-dimensional geofence; a three-dimensional geofence; or any combination thereof.

36. An article comprising:
a non-transitory storage medium having instructions stored thereon executable by a special purpose computing platform to:
obtain multiple position fixes of one or more objects over an area or volume;
determine a clustering of said multiple position fixes in a portion of said area or said volume; and
infer a geofence boundary bounding said portion of said area or said volume based, at least in part, on said clustering of said multiple position fixes.

37. The article of claim 36, wherein said storage medium further comprises instructions to:
partition said area into one or more segments;
count said multiple position fixes within said one or more segments; and
identify at least one contiguous segment based, at least in part, on at least a threshold number of said multiple position fixes, wherein to said infer said geofence boundary comprises to infer said boundary to bound said at least one contiguous segment.

38. The article of claim 36, wherein said storage medium having said instructions to said determine said clustering of said multiple position fixes further comprises instructions to:
identify at least one attribute of said multiple position fixes; and
cluster said multiple position fixes based, at least in part, on said at least one attribute.

39. The article of claim 38, wherein said at least one attribute comprises at least one of the following: latitude; longitude; altitude; time; or any combination thereof.

40. The article of claim 36, wherein said storage medium having said instructions to said infer said geofence boundary further comprises instructions to infer said geofence boundary based, at least in part, on a probability density function of said multiple position fixes of said one or more objects.

41. The article of claim 40, wherein said storage medium having said instructions to said infer said geofence boundary further comprises instructions to bound a peak of said probability density function defined by at least one of the following: a threshold number of said multiple position fixes; a threshold number of a density of probability of said multiple position fixes; or any combination thereof.

42. The article of claim 36, wherein said geofence boundary is associated with at least one of the following: a two-dimensional geofence; a three-dimensional geofence; or any combination thereof.
